(19) United States
(12) Patent Application Publication
(10) Pub. No.: US 2025/0128358 A1
(43) Pub. Date: Apr. 24, 2025

(54) METHOD AND SYSTEM FOR ANALYZING A LASER MACHINING PROCESS ON THE BASIS OF A SPECTROGRAM

(71) Applicant: PRECITEC GMBH & CO. KG, Gaggenau (DE)

(72) Inventor: Joachim Schwarz, Kleinandelfingen (CH)

(21) Appl. No.: 18/683,204

(22) PCT Filed: Aug. 12, 2022
(86) PCT No.: PCT/EP2022/072721

§ 371 Date: Feb. 12, 2024

(30) Foreign Application Priority Data
Aug. 13, 2021 (DE) 10 2021 121 112.3

(51) Int. Cl. B23K 26/70; B23K 26/38

(52) U.S. Cl. CPC B23K 26/707; B23K 26/38

(57) ABSTRACT

A method for analysing a laser machining process includes the steps of: detecting a plurality of spectra of process emissions at successive points in time; generating at least one spectrogram on the basis of the detected spectra; and determining at least one prediction value of a physical quantity and/or determining at least one classification of the laser machining process by means of a trained neural network, wherein the neural network receives the spectrogram as input tensor and outputs the physical quantity and/or the classification of the laser machining process as output tensor.

### CROSS-REFERENCE TO RELATED APPLICATIONS

This application is the U.S. National Stage of PCT/EP2022/072721 filed on Aug. 12, 2022, which claims priority to German Patent Application 102021121112.3 filed on Aug. 13, 2021, the entire content of both are incorporated herein by reference in their entirety.

### FIELD OF THE INVENTION

The present disclosure relates to a method for analysing a laser machining process and to a system and a laser machining system for analysing a laser machining process, in particular based on a spectrogram.

### BACKGROUND OF THE INVENTION

In a laser machining process, a workpiece, in particular a metallic workpiece, is machined using a machining laser. The machining can include, for example, laser cutting, laser soldering and/or laser welding. The laser machining system can include a laser machining head, for example.

Laser machining processes are often subject to quality control. In particular, when laser welding or laser soldering a workpiece, the quality of the resulting joint is checked. Current monitoring systems for process monitoring and quality assessment during laser welding, laser soldering or laser cutting are usually based on pre-, in- and/or post-process monitoring systems. A pre-process monitoring system typically has the task of detecting or measuring a joining gap before the laser machining process in order to guide the laser beam to the appropriate position and determine the offset of the joining partners. In most cases, triangulation systems are used for this purpose.

In-process and post-process monitoring systems are regularly used to monitor laser machining processes and to control and ensure the quality of the resulting joint. Post-process monitoring in particular is often used for quality monitoring, as the result of the laser machining process, for example a finished and cooled weld seam, can be examined and measured in accordance with applicable standards (e.g. SEL100). Post-process monitoring or post-inspection requires a great deal of plant engineering effort. A separate measuring cell often has to be set up for post-process monitoring.

In-process monitoring systems (also known as inline or online process monitoring systems) are typically designed to detect at least part of the radiation emitted by the laser machining process. In many cases, not all signals can be recorded and processed with frequency and spatial resolution using the in-process monitoring systems. It is therefore difficult to realise quality monitoring based on these monitoring systems that would allow classification into error classes. In a laser machining process, radiation is usually emitted from a molten pool in the visible range between about 400 nm and 850 nm, from a plasma in the range between about 400 nm and 1100 nm, from backscattered light from a machining laser in the range between about 900 nm to 1100 nm and temperature radiation in a range >1000 nm. In other words, the laser machining process emits radiation in a wide range between about 400 and 1800 nm. This radiation is also called process emission or process radiation.

Depending on the application, spectral detection can be restricted to certain wavelength ranges when tests in the application show, for example, that a spectral radiation range, e.g. temperature radiation, does not contain any information about quality characteristics that are of interest. In the case of joints between different metals, it is particularly advantageous to obtain frequency-related or frequency-dependent intensities of the process emissions, as a spectrum can prove whether spectral lines of both joining partners are present in the spectrum in the case of an overlap weld, for example. A spectrum of the process emissions can also indicate changes in the alloys. Such changes can be caused, for example, by the use of materials from different manufacturers. Changes in the alloys can influence joining, cutting and laser printing processes. During laser removal, a spectrum can show whether a coating is actually being removed or whether material under the coating is being heated by the laser or converted into plasma.

In existing in-process monitoring systems, diodes are typically used to analyse process radiation, wherein the radiation is detected in narrow bands. As a rule, photodiodes with different sensitivities are used. For example, a Si diode can detect the range between about 400 nm and 800 nm, an InGaAs diode can detect the range between about 800 nm and 1200 nm and another InGaAs or Ger diode can detect the range between about 1200 nm and 2000 nm. Depending on the process, areas can be cut out of these wavelength ranges using appropriate optical filters. For example, depending on the machining laser, the area for the backscattered laser radiation can be reduced to about 1020 nm to 1090 nm. Wavelengths outside these detection ranges of the diodes and the optical filters are not detected. Intensity components of narrow wavelength ranges are no longer visible in the integrated intensity over large wavelength ranges.

The intensity curves recorded in this way using such diodes are typically filtered and checked for exceeding calculated or specified threshold values. The filter parameters and threshold values are set separately for each signal, i.e. for the respective wavelength range. The observation and evaluation of a single diode thus corresponds to a separate sensor system.

For quality monitoring, reference curves can also be formed from many recorded signal curves and so-called envelope curves can be placed around these reference curves. The envelope curves represent the threshold values for each point in time of a weld. If a signal exceeds or falls below the values of an envelope curve during the laser machining process, an error message is indicated or output using previously defined error criteria. Criteria can be, for example, an integral of the signal over the envelope curve or the exceeding of the signal over the envelope curve. One example of such a system is the LWM product from Precitec.

The evaluation of spectra and the classification or regression based on the spectra cannot be realised satisfactorily using a feature-based approach. In particular, conclusions about certain types of errors cannot be reliably performed.

Other solutions can be based on imaging sensors, wherein image processing is used, for example, for analyses and/or measurements of the melt pool and the keyhole in order to enable a quality statement to be made with the measurement data obtained in this way.

With the use of InGaAs sensors, typically only thermal profiles in the range above about 1200 nm are evaluated, as disclosed, for example, in DE 10 2008 058 187 A1, wherein a method and a device for the non-destructive quality determination of a weld seam and welding device are described.

Furthermore, brightness profiles can be recorded with CMOS sensors in the range between about 450 nm and 800 nm, wherein these brightness profiles are compared with assumed models and quality features are recognised. DE 10 2011 078 276 B3 describes such a method for recognising errors during a laser machining process.

The recording of intensity versus frequency and the evaluation of spectra is described e.g. in patent specifications US 2014 149075. In both cases, the evaluation refers to the data of a single spectrum, wherein various features in the spectrum are used to evaluate the laser process. In DE 10 2008 043 820, the frequency component that is significant for the laser machining process is selected by the user. The large integration effort required when using spectrometers due to the structural size and the required accuracy prevent the use of this technology in series production.

### SUMMARY OF THE INVENTION

It is therefore a task of the invention to provide a method and a system for analysing a laser machining process for reliably assessing the quality of the laser machining. Furthermore, it is a task of the invention to detect machining errors reliably and quickly and without complex parameterisation processes.

Moreover, it is a task of the invention to automate the assessment of the quality of a laser machining and the detection of machining errors and thus to enable process monitoring, in particular online process monitoring.

It is a further task of the invention to adjust conditions or parameters for a laser machining process on the basis of prediction values and/or classifications.

One or more of these tasks is solved by the features as disclosed herein.

According to one aspect, a method for analysing a laser machining process comprises the following steps: detecting a plurality of spectra of process emissions at successive points in time or in periods of time, respectively; generating at least one spectrogram on the basis of the detected spectra; and determining at least one value or prediction value of a physical quantity or physical property and/or determining at least one classification of the laser machining process by means of a trained neural network, wherein the neural network receives the spectrogram as input tensor and outputs the physical quantity and/or the classification of the laser machining process as output tensor. The laser machining process can be, for example, a laser cutting, laser welding, laser soldering or laser removal process.

In other words, the at least one value and/or at least one classification of the laser machining process can be determined based on the at least one spectrogram by means of a transfer function formed by the trained neural network.

The neural network can be taught by error feedback or backpropagation. The neural network may be a convolutional neural network and/or a deep neural network, e.g. a deep convolutional neural network or convolutional network. The convolutional network may have at least one so-called “fully connected” layer.

The method according to the invention allows to efficiently draw conclusions about certain types of errors or certain classifications without having to process the detected data and analyse it separately with computer support by means of a classic feature analysis. The use of neural networks, in particular convolutional neural networks, allows to analyse spectrograms with regard to certain errors and to classify and/or map physical quantities or physical properties without having to know or extract the features in the spectrograms. Such errors can be, for example, defective in-welding when welding different materials or coating inclusions in welding zones. Machining errors can therefore be identified reliably, quickly and without complex parameterisation processes. In other words, a particularly efficient, automated and simple quality assurance process can be carried out for each machined workpiece. The neural network is also particularly sensitive and, depending on the training, minor changes or difficult-to-recognise defects or machining errors can be identified.

The at least one spectrogram serves as an input data set or input tensor for the trained neural network. Several detected or recorded spectra can be combined as a spectrogram to form an input tensor for the neural network. Preferably, each generated spectrogram can form a separate input tensor. The spectrogram can represent a composition of the process emissions from individual frequencies over time. The spectrogram can therefore be a time-variant representation of the frequency distribution of the process emissions, for example using the short-time Fourier transform.

The trained neural network outputs the value of at least one physical property or classification as an output tensor. The neural network can also determine values of several physical properties and/or classifications simultaneously and output them as an output tensor. The simultaneous quantification of several physical properties and/or classifications of the machining result means that the laser machining process can be monitored more reliably and accurately.

In particular, the quality of a laser machining process can be assessed by evaluating a workpiece that has just been machined. From this, it can be deduced whether the machining operation leads to the desired criteria of the machining process or the workpiece, or whether machining errors occur. The determination of the at least one value or prediction value and, in particular, the detection of machining errors can be automated and thus process monitoring, in particular online process monitoring, can be enabled.

The laser machining process can be performed on at least one workpiece, in particular a metallic workpiece, e.g. made of pure metals and/or alloys. In particular, a workpiece can comprise several composite initial workpieces. In other words, two metallic parts or initial workpieces made of the same material or of different materials can be joined, for example welded, by means of the laser machining process.

The process emissions are generated on the workpiece, for example during laser machining, i.e. during or shortly after laser machining, and are at least partially detected by a detector or a sensor, in particular by a detector of a spectrometer.

The at least one spectrogram can be detected during the laser machining process being performed. Likewise, the value of the physical property can be determined during the performance of the laser machining process or also after the end of the laser machining process. Accordingly, the method according to the invention can be formed in particular as an in-process method. The determination of the at least one physical property and/or the classification of the laser machining process can therefore take place in particular in real time.

The method according to the invention can be performed continuously and/or repeatedly during the laser machining process. In other words, spectra and/or spectrograms can be detected continuously and/or repeatedly and the value of the at least one physical property and/or classification can be determined in each case.

The generation of the spectrogram may have a chronological assembly of at least one part or several of the plurality of detected spectra, wherein each spectrum is or can be assigned to a point in time or a time interval at which it is detected. The detected spectra are recorded at successive points in time. The recording can take a few nanoseconds to milliseconds, for example, which is why the point in time at which a spectrum is recorded can actually correspond to a short period of time. Nevertheless, a point in time can be approximated. For example, a spectrum can be assigned to a point in time at which the detection or recording of the spectrum begins.

The invention is thus based on the idea of using a neural network to specify a value for a physical property and/or a classification of the machining result, i.e. to quantify the physical property and/or to classify the laser machining process or the machining result, wherein the neural network uses at least one spectrogram recorded for the laser machining process as an input data set. With the aid of the method according to the invention, it is therefore possible to determine the value of the physical property and/or a classification of the machining result of the laser machining process in a non-destructive manner. The physical property can be a quality feature of the machining result, which can, for example, be specified by a standard or a norm, e.g. relating to a material property. Accordingly, a quality of the machining result, for example of weld seams or solder seams and cut edges, can be quantified or quantitatively described and evaluated on the basis of the determined value of the physical property in order to specify a fine-grained evaluation metric for analysing the weld seams or solder seams and cut edges and the corresponding laser machining processes.

In summary, the method according to the present invention allows monitoring, in particular real-time monitoring, of a laser machining process, in particular a laser cutting, laser welding, laser soldering or laser removal process, from spectrograms by means of machine learning methods.

Detecting each of the spectra can include detecting intensities of the process emissions as a function of the wavelength at the respective point in time. Instead of the intensities of process emissions, absorptions, for example infrared absorptions, can also be detected. A spectrum usually comprises the plotting or assignment of intensities to wavelengths, wherein wavelengths are usually specified in in the unit nanometres. Alternatively, the plotting or assignment of an intensity against a wavelength can also be replaced by the plotting or assignment of an intensity against a frequency, whereby a frequency is specified in the unit Hz.

The detected intensities can be raw data. The assessment of the quality of a laser machining process and the detection of machining errors of a machined workpiece and in particular of a workpiece surface can therefore be carried out on the basis of recorded raw data. This is called “end-to-end” processing or analysis. Analysing raw data can reduce the number of steps required to analyse a laser machining process, whereby a particularly efficient method can be provided. Complex pre-processing or data preparation can therefore be omitted. In particular, it is not necessary for a program or user to perform mathematical operations to analyse the detected intensities and detected spectra. This makes the process particularly simple, time- and cost-efficient. Raw data includes, for example, intensities that are determined on the basis of an electrical signal from a sensor or detector. Raw data can, in particular, be data that does not undergo any further mathematical treatment or operations after detection, such as filtering, smoothing, normalisation, etc.

In in-process monitoring systems in particular, raw data can be used to analyse a laser machining process in order to be able to carry out an analysis or evaluation in real time particularly quickly and efficiently.

The detected intensities of a single spectrum can be recorded essentially simultaneously. The simultaneous detection of intensities of different wavelengths of a spectrum allows all intensities for a specific state of the workpiece to be detected at a point in time, whereby this state can be mapped completely and reliably. Furthermore, the simultaneous detection of the intensities of a spectrum is particularly efficient.

Detecting each spectrum can involve localised spectral splitting at a detector. The spectral splitting at or in front of a detector can be performed, for example, by means of a grating and/or a prism. Preferably, however, spectral splitting is performed by reflection. A grating may be preferred because it works “in reflection” and does not absorb any parts of the spectral emissions through a material and thus falsifies the signals or spectra. In particular, spectral splitting allows all or at least some of the intensities of a spectrum to be recorded simultaneously.

The process emissions include, for example, temperature radiation, plasma radiation and/or laser radiation reflected from the surface of a workpiece. Prediction values for physical quantities and/or classifications of the laser machining process can be derived from the aforementioned process emissions, particularly in characteristic spectral ranges or wavelength ranges. In particular, said process emissions provide an indication of machining errors.

In particular, generating of the at least one spectrogram may comprise: generating of a first spectrogram for a first time interval and generating of a second spectrogram for a second time interval, wherein the second time interval overlaps with and/or immediately follows the first time interval.

In the case of a temporal overlap of spectrograms, for example, a first spectrogram can be generated from spectra of about 0 ms to 500 ms and a second spectrogram can be generated from the spectra of about 400 ms to 900 ms. The overlap can depend on the error size and the machining speed, i.e. the time in which a significant feature is formed across the spectra. In particular, time intervals of two or more generated spectrograms are the same length and/or have the same number of spectra, regardless of whether the spectrograms overlap in time or not. Alternatively, the time intervals can also differ in length.

In particular, the physical quantity may comprise at least one of the following: a tensile strength, a compressive strength, an electrical conductivity, a keyhole depth, a weld-in depth, a gap size of a gap between two workpieces joined by the laser machining process, a roughness of a cut edge of a workpiece cut by the laser machining process, a burr of a cut edge of a workpiece cut by the laser machining process, a burr height of a cut edge of a workpiece cut by the laser machining process, a steepness of the cutting front and a perpendicularity of a cut edge of a workpiece cut by the laser machining process. The classification of the workpiece can include a classification into an error class, in particular at least one of the following: gap, offset, missing penetration and/or weld-in, defective removal, cut quality and alloy quality.

A classification can also be determined on the basis of said physical quantity. In particular, the classification can represent whether a workpiece corresponds to a good weld or a bad weld, wherein a good weld is a welding result that fulfils predetermined criteria and a bad weld is a welding result that does not fulfil predetermined criteria.

The spectra can be detected, for example, at a sampling rate between about 100 Hz and 100 kHz, preferably between about 800 Hz and 10 kHz and in particular between about 900 Hz and 2 kHz. A high sampling rate leads to a high temporal resolution of the spectrograms.

In particular, the spectra can be detected in a wavelength range between about 100 nm to about 1500 nm, preferably between about 130 nm to 1300 nm, particularly preferred between about 150 nm and 1050 nm and especially between about 340 nm and 850 nm. Most of the physical values or classifications of the laser machining process can be derived from the spectra of the said wavelength ranges.

The spectra can be detected with a spectral resolution of between about 0.1 nm and 1 nm, preferably between about 0.2 nm to 0.8 nm and particularly preferred between about 0.4 nm to 0.6 nm. The spectral resolution results in particular from the spectral splitting at or in front of the detector. The stronger the splitting at a grating or another dispersive optical element, the higher the spectral resolution can be, provided the detector allows this.

The value or prediction value of the physical quantity and/or the classification can be determined in real time. Based on this, closed-loop control data and/or control data can be output to a laser machining system performing the laser machining process. The value of the physical property and/or the classification can thus be used to closed-loop control the laser machining process, in particular when the respective value is determined during the performance of the laser machining process. For example, the laser machining process can be closed-loop controlled in such a way that a difference between the determined value or an actual value and a target value of the physical property of the current machining result or a subsequent machining result is reduced. For example, when the physical property is the weld-in depth in a workpiece and the determined value of the weld-in depth deviates from a target value of the weld-in depth, the laser machining process can be adapted so that a difference between the determined value of the weld-in depth and a current target value decreases for a subsequent laser machining process. A closed-loop control of the laser machining process can include an adjustment of a focus position, a focus diameter of the laser beam, a laser power and/or a distance of a laser machining head.

In particular, the laser machining process can be controlled and/or closed-loop controlled automatically on the basis of prediction values and/or classifications. For example, a prediction value for a physical quantity can form the basis for controlling or closed-loop controlling the laser power of a machining laser. In particular, this can prevent machining errors from occurring. In addition, machining errors on a workpiece can also be corrected by closed-loop controlling and/or controlling the laser machining process. In addition, such a method can lead to a workpiece with the desired physical properties being generated by means of the laser machining process, thereby fulfilling very high quality criteria. In particular, the conditions for a laser machining process can be adjusted on the basis of prediction values and/or classifications.

As a result, workpiece rejects due to machining errors can be reduced or avoided, which is particularly important for very high-quality workpieces from an economic and ecological point of view. In addition, a workpiece can be improved by an optimised laser machining process compared to other workpieces produced by known laser machining processes, i.e. the physical properties of a machined workpiece according to the invention can meet particularly high quality requirements. For example, an electrical contact can have essentially no defects, a particularly long service life and particularly good conductivity thanks to an optimised laser machining process.

The data detected for a workpiece, in particular the spectrograms and the prediction values and/or classifications determined from them, can also be recorded and stored and attached to the product on a product data sheet for warranty purposes, for example. This is of particular interest for very high-quality workpieces or workpieces that have to fulfil high safety standards.

The trained neural network can be adapted by means of training data through transfer learning. In particular, the neural network can be adapted to changing process conditions, for example due to a new batch of workpieces with a slightly different material composition. A adaptable neural network that can be (re) trained by means of training data through transfer learning is particularly flexible, versatile and user-friendly.

The requirements for laser machining processes and the resulting workpieces can be diverse and varied. For example, a user may be interested in very specific physical parameters of their workpieces, as this allows them to map very specific properties of the workpieces they are interested in.

Transfer learning can be used to retrain a neural network, for example when the neural network outputs incorrect prediction values or classifications. For transfer learning, training data can be created on a workpiece that is specially machined for the training. Spectra are detected for a workpiece machined for training purposes and spectrograms are generated, which are used as training data for the neural network together with the respective measured values of the physical quantity and/or classifications made by experts (so-called “ground truth” values). The measurement of a physical quantity or the classification by experts is carried out on the basis of the machined workpiece and, if necessary, using destructive techniques.

Transfer learning can be used to adapt the neural network to a changed situation or a changed laser machining process. The changed situation can be, for example, that the workpieces to be machined have different materials, degrees of contamination and/or thicknesses, or that the laser machining parameters are changed. In transfer learning, new examples can be added to the training data sets used to train or teach the neural network. The use of a trained neural network that is arranged for transfer learning therefore has the advantage that the system can be quickly adjusted to changed situations, in particular to a changed laser machining process.

The neural network can be a CNN, which can include fully connected layers, it can include LSTM (“long short term memory”) layers and/or at least one GRU (“gated recurrent units”) layer. This can improve the performance of the neural network.

According to a further aspect, a system for analysing a laser machining process is disclosed. The system may be adapted to perform the method and, in particular, an embodiment of the method. The system comprises: at least one sensor or a sensor unit, preferred with a sensor field, arranged to detect a plurality of spectra of process emissions at successive time points; and at least one computing unit (also called a controller) arranged to generate at least one spectrogram based on the detected spectra as an input tensor; and a neural network arranged to calculate, based on the input tensor, at least one value or predicted value of a physical quantity or property and/or a classification of the laser machining process as an output tensor. The neural network can be contained or implemented in the computing unit. Alternatively, the neural network can be provided in a server or a cloud. In this case, the neural network can be connected wirelessly to the computing unit for data exchange.

The system for analysing a laser machining process realises all the advantages that also apply to the method and in particular one or more of the embodiments of the method.

The spectra of process emissions can be detected at least partially coaxially with the beam path of a machining laser for performing the laser machining process. This allows the system to be designed in a particularly space-saving and efficient manner. Optical elements can therefore be utilised efficiently and additional optical elements that would be required for a non-coaxial beam path can be dispensed with.

The computing unit can be adapted to determine the value in real time and/or output closed-loop control data to a laser machining system performing the laser machining process.

The sensor or the sensor unit can have at least one spectrometer, in particular a MEMS spectrometer. MEMS (micro-electro-mechanical systems) are particularly cost-efficient and space-saving, and are therefore easy to integrate into or onto laser machining heads. MEMS devices can be used in “on-chip” spectrometers. This enables the integration of these miniaturised spectrometers into laser material machining heads. In particular, the sensor or sensor unit can have two, three, four, five, six, seven, eight, nine, ten or even more MEMS spectrometers.

The computing unit can be adapted to closed-loop control and/or control the laser machining process on the basis of closed-loop control data and/or control data.

Such a system can generate high-quality workpieces autonomously, i.e. without the intervention of a user. A laser machining process that leads to machining errors can thus be corrected or even terminated in order to ensure that the workpieces meet the user's individual quality requirements. In particular, various parameters of the laser machining process can be controlled and/or closed-loop controlled to ensure that a workpiece has essentially no machining errors.

According to a further aspect, a laser machining system for machining a workpiece by means of a machining laser beam comprises: a laser machining head for irradiating the machining laser beam onto the workpiece; and the system for analysing a laser machining process according to the present disclosure, and in particular an embodiment thereof.

The laser machining system for machining a workpiece also realises all the advantages that also apply to the method and, in particular, to one of the embodiments of the method.

### BRIEF DESCRIPTION OF THE DRAWINGS

Embodiments of the present invention are described in detail below with reference to figures. The figures depict various features of embodiments, wherein the features are not limited to the embodiments alone. Rather, all features that are not mutually exclusive can also be combined with each other or features can be removed from embodiments, provided that they are not essential for carrying out the invention.

FIG. 1 is an exemplary spectrum during a laser machining process at a point in time;

FIG. 2 is an exemplary spectrogram of a laser machining process;

FIG. 3 is a schematic representation of a functional principle of a spectrometer according to an embodiment;

FIG. 4 is a schematic representation of a laser machining head with a spectrometer according to one embodiment; and

FIG. 5 is a schematic representation of a method for analysing a laser machining process according to one embodiment.

### DETAILED DESCRIPTION OF THE EMBODIMENTS

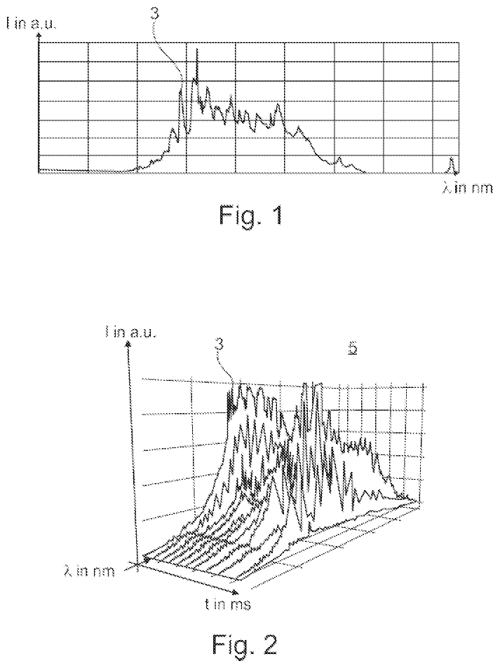

FIG. 1 is an exemplary spectrum 3 of a laser welding process of aluminium on steel at a point in time t. Intensities I are plotted on the vertical axis against wavelengths λ on the horizontal axis. The result is the spectrum 3 shown.

Spectrum 3 was detected by means of a spectrometer. Spectrometers allow the intensity of light, especially of process emissions, to be determined as a function of wavelength or frequency. Characteristic lines of metallic workpieces as well as their coatings and process emissions significant for the laser machining process are not masked by emissions that have no influence on the quality or regression assignment, as can happen when selectively viewing only a section of the spectrum of the process emissions. This enables a complete picture and therefore a more reliable quality analysis.

The main part of the spectrum 3 in FIG. 1, namely the highest intensities of the spectrum, are in the visible spectral wavelength range 2 of light, namely between about 400 nm and about 730 nm.

FIG. 2 is an exemplary spectrogram 5 of a laser machining process over a period of about 0.2 seconds. The spectrogram 5 is assembled from a large number of individual spectra 3, which are plotted against time along the time axis. In other words, the individual spectra 3 are arranged in a spectrogram 5 and can thus be visualised over time. The combination of spectra to form an image is achieved by each line of the image consisting of the intensities of a spectrum.

Spectra can, for example, be recorded at a rate of about 1 KHz over a period of about one second and arranged in time so that a spectrogram or an image with 1000 lines is generated. The line length results from the resolution of the spectrometer. In a wavelength range from about 150 nm to 1050 nm and a resolution of about 0.5 nm, for example, this results in a line length of 1800 intensity values. The resolution of the individual data points is 16 bit, for example.

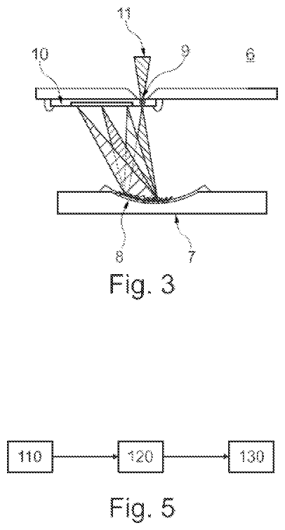

FIG. 3 is a schematic representation of the operating principle of a spectrometer. A part of the process emissions fall as incident light 11 through a gap 9 or slit onto a reflective concave grating 8 of a grating chip 7. The light is spectrally split at the grating 8 and directed onto a sensor 10, in particular onto a sensor field.

The spectrometer 6 shown in FIG. 3 may in particular be a MEMS spectrometer, which is particularly cost-effective and easy to integrate into a laser machining head. The development of spectrometers “on chip”, based on MEMS spectrometers, enables the integration of this technology in laser material machining heads. In particular, a line sensor can be used as the detector or sensor 10, onto which the spectrally split light falls or is imaged. The data can be read out at the sensor 10 with a resolution of 16 bits, for example. Data rates in the kHz range per spectrum can be realised.

A MEMS spectrometer from the company Hamamatsu (C12666MA) with a spectral resolution of about 15 nm in a range of about 340 nm to 850 nm is cited as an example of a spectrometer 6. The use of several MEMS spectrometers for different wavelength ranges is easily possible by combining the individually detected spectra and arranging them into a spectrogram. The wavelength ranges preferably border directly on each other or overlap in a small area.

The data or spectra, in particular the wavelength-dependent intensities, are then read out and combined to form a spectrogram 5, as shown as an example in FIG. 2. For example, a first spectrogram 5 can be generated from spectra 3 of about 0 ms to 500 ms, and a second spectrogram 5 can be generated from spectra 3 of about 400 ms to 900 ms, etc. In this case, there is an overlap which depends on the error size and welding speed, i.e. on the time in which a significant feature is formed across the spectra.

The number of spectra 3 in the spectrogram 5 can be selected depending on the application, depending on the length or duration of the machining process, e.g. a weld, and the sufficient exposure of the line sensor in the MEMS device.

The use of neural networks allows the spectrograms 5 to be classified according to errors and/or mapped to physical quantities without having to know or extract the features in the spectrograms 5. For this purpose, no errors are defined in the data of the individual spectra 3 or spectrograms 5, which represent the so-called ground truth, but welded workpieces are used to determine the ground truth.

For classification or regression of the input data into a quality class or mapping to a value of a physical quantity, e.g. for strength or conductivity, the machining result, e.g. a welded joint, is subjected to a measurement, e.g. a force measurement or a conductivity measurement. This can be used to physically determine the force at which a weld seam tears or the conductivity which has been created between the joined materials.

These values can be used as ground truth to train or adjust a neural network, in particular a convolutional neural network. The intensity distribution in the individual spectra 3 and its progression over time therefore need not be known to the user.

The spectrogram 5 forms an input tensor for the neural network, in particular a deep, typically convolutional, neural network, which classifies the spectrogram 5, for example, according to a type of error. The neural network can, for example, have a network of the XCeption architecture.

The classification into typical error classes, such as gap, offset, missing weld penetration and weld-in and defective removal, requires the generation of a large number of training data which have these typical errors. Welds must therefore be generated for each type of error. The strength, conductivity or other physical quantities must be determined for each weld, depending on which classes are to be classified or which physical values are to be mapped. This provides a clear assignment of the data to the ground truth. Therefore, the cumbersome determination of significant features from the spectrograms 5 can be dispensed with.

When welding different materials, the spectrogram 5 will change depending on the proportions of the joining partners in the joining process. The regression to a value for a weld-in depth for overlap joints of different materials is made possible using the spectrograms 5 as an input tensor.

Different cut qualities, caused among other things by alloy changes in the materials, can be recognised based on the spectrograms 5. Classification into cut qualities is made possible by using the spectrograms 5 as input tensors.

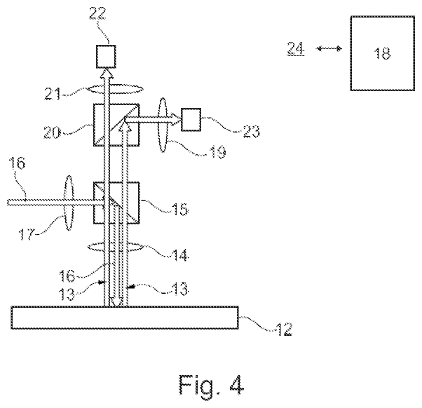

FIG. 4 is a schematic representation of a laser welding head 24 with spectrometers 22, 23 as an example of a laser machining head according to one embodiment. The beam path of the machining laser beam 16 runs via collimating optics 17, a beam splitter 15 and focussing optics 14 onto a workpiece 12, which is being machined. During machining, process emissions 13 are generated, for example thermal radiation, plasma radiation and/or laser radiation reflected from the surface of a workpiece. A part of the process emissions 13 are at least partially guided coaxially or collinearly to the beam path of the machining beam 16 from the surface of the workpiece to one of the two spectrometers 22, 23. The process emissions 13 are split at the beam splitter 20. A part of the process emissions 13 are reflected by the beam splitter 20 via the imaging optics 19 to the spectrometer 23, which can detect wavelengths between about 300 nm and 1050 nm, for example. Another part of the process emissions 13 is transmitted through the beam splitter 20 via the imaging optics 21 to the spectrometer 22, which can detect wavelengths between about 1000 nm and 1400 nm, for example.

The laser welding head 24 is connected to a computing unit 18, which performs computing operations, in particular assembles spectra 3 into spectrograms 5 and comprises or uses a neural network to determine physical quantities and/or classifications and, in particular, identifies machining errors.

FIG. 5 shows a schematic representation of a method for analysing a laser machining process according to one embodiment. In step 110, a plurality of spectra of process emissions are detected by a spectrometer at successive points in time or periods of time. In other words, the spectrometer detects intensities at different wavelengths at a determined point in time or in a determined period of time, wherein a data set of the intensities and the associated wavelengths represents a spectrum. In step 120, spectrograms are generated on the basis of the detected spectra. The spectrograms are generated by plotting a plurality of spectra along a time axis against the time t at which they were detected. In step 130, a neural network is used to determine a value of a physical quantity and/or a classification of the laser machining process. The neural network receives the spectrogram as an input tensor and generates the value of the physical quantity and/or the classification of the laser machining process as an output tensor.

The neural network is in particular a convolutional neural network and can, for example, consist of an XCeption network. The input layer can be adjusted to the dimension of the spectrogram (e.g. 2315×500×1). The dimension of the latter results e.g. from the probabilities to be predicted for the classes into which classification is to be made, for example gap, missing weld-through or weld-in and offset.

The laser machining process described herein can include joining or connecting workpieces or separating or removing material. The laser machining process can be or comprise a laser cutting process, a laser removal process, a laser welding process or a laser soldering process. The machining result of the laser machining process may comprise the cut, joined or connected, i.e. the welded or soldered or cut workpieces. In particular, the machining result in this case can denote a welded joint or soldered joint between the joined workpieces. The welded joint or soldered joint can be formed by a weld seam. In other words, the machining result in this case can designate the weld seam or soldered seam. The machining result may also denote a part or area of the welded joint or the welded seam. There may be a gap between the workpieces to be joined by the laser machining process, which has an influence on the result of the weld. The gap can, in the case of butt welding, be described as the space between two opposing surfaces of the workpieces to be joined or, in the case of overlap welding, as the space between the workpieces to be joined. A distance between the opposing surfaces of the joined workpieces can be referred to as the gap size. A gap that is too large can represent a machining error in the laser machining process. In the case of butt joint welding, the gap is determined in the pre-process, i.e. before welding; in the case of overlap welding, the gap is determined using the clamping technology.

The machining result of the laser machining process can also include an intermediate result of the laser machining process, i.e. a feature that is (also or only) present during the performance of the laser machining process. In particular, the machining result may comprise a vapour capillary, also known as a “keyhole”, and/or a melt pool. A keyhole depth can be defined as the distance between the base of the vapour capillary and the surface of the workpiece onto which the laser beam is irradiated. The weld-in depth can be inferred from the keyhole depth.

The value of the physical property of the machining result can correspond to a value predicted for a measurement of the physical property of the machining result. In other words, the determination of the value of the physical property can be regarded as a prediction of a measured value of the physical property.

The at least one physical property of the machining result may comprise at least one of the following: a strength, in particular a tensile strength, a compressive strength and/or a shear strength, of a welded joint or soldered joint produced by the laser machining process, an electrical conductivity of a welded joint or soldered joint produced by the laser machining process, a keyhole depth, a weld-in depth in a workpiece, a gap size between two workpieces joined by the laser machining process, a roughness of a cut edge of a workpiece cut by the laser machining process, a burr or a burr height of a cut edge of a workpiece cut by the laser machining process, a steepness of the cutting front and a perpendicularity of a cut edge of a workpiece cut by the laser machining process. When the keyhole depth or the steepness of the cutting front is determined or predicted by means of the method according to the invention, separate measuring devices, for example optical coherence tomographs, can be dispensed with in a laser machining system for performing the laser machining process. Determining a value for tensile strength, on the other hand, is particularly relevant for workpieces that are butt-jointed. The machining result during laser cutting can be described by the physical properties, such as the roughness of the cut edges or the burr or burr height of the cut edges or the perpendicularity of the cut edges.

The value of the physical property can be determined in a physical unit, e.g. in an “SI unit” (International System of Units). For example, strength can be determined in Newtons (N) or Newtons per area (N/m²), the weld-in depth in μm, the gap size in μm and the electrical conductivity in Siemens(S). The roughness of a cut edge can be determined e.g. with the unit μm.

All discrete values given herein may deviate up to about 10% and in particular up to about 5-7% from the specifications. Therefore, the specifications are to be understood only as approximate.

### LIST OF REFERENCE NUMERALS

3 Spectrum
5 Spectrogram
6 Sensor or spectrometer device
7 Grating chip
8 Reflective concave grating
9 Gap
10 Sensor field
11 Incident light
12 Workpiece
13 Process emissions
14 Focussing optics
15 Beam splitter
16 Machining beam
17 Collimating optics
18 Computing unit
19 Imaging optics
20 Beam splitter
21 Imaging optics
22 Spectrometer
23 Spectrometer
24 Laser welding head
110 Detecting a plurality of spectra in a spectrometer
120 Generating at least one spectrogram based on the detected spectra
130 Determining at least one prediction value of a physical quantity and/or determining at least one classification of the laser machining process by means of a trained neural network

1. A method for analysing a laser machining process, comprising:
detecting a plurality of spectra of process emissions at successive points in time;
generating at least one spectrogram based on the detected spectra; and
determining at least one value of a physical quantity and/or determining at least one classification of the laser machining process by means of a neural network,
wherein the neural network receives the spectrogram as an input tensor and outputs the physical quantity and/or the classification of the laser machining process as an output tensor.

2. The method according to claim 1,
wherein detecting each of the spectra comprises detecting intensities of the process emissions as a function of the wavelength at the respective point in time.

3. The method according to claim 2, wherein the detected intensities are raw data.

4. The method according to claim 2, wherein the detected intensities of a spectrum are detected simultaneously and/or wherein the detection of each spectrum comprises a local spectral splitting at a detector.

5. The method according to claim 1,
wherein the process emissions comprise a temperature radiation, a plasma radiation and/or a laser radiation reflected from a surface of a workpiece.

6. The method according to claim 1, wherein generating the at least one spectrogram comprises:
generating of a first spectrogram for a first time interval and generating of a second spectrogram for a second time interval, wherein the second time interval overlaps with and/or immediately follows the first time interval; and/or
chronological assembling of the plurality of spectra.

7. The method according to claim 1,
wherein the physical quantity comprises at least one of the following: a tensile strength, a compressive strength, an electrical conductivity, a keyhole depth, a weld-in depth, a gap size of a gap between two workpieces joined by the laser machining process, a roughness of a cut edge of a workpiece cut by the laser machining process, a burr of a cut edge of a workpiece cut by the laser machining process, a burr height of a cut edge of a workpiece cut by the laser machining process, a steepness of the cutting front and a perpendicularity of a cut edge of a workpiece cut by the laser machining process; and/or
wherein the classification of the workpiece corresponds to a classification into a error class and comprises at least one of the following: gap, offset, missing weld penetration and/or weld-in, defective removal, cut quality and alloy quality.

8. The method according to claim 1, wherein the spectra are detected at a sampling rate between about 100 Hz and 100 kHz or between about 800 Hz and 10 kHz or between about 900 Hz and 2 kHz.

9. The method according to claim 1,
wherein the spectra are detected in a wavelength range between about 100 nm to about 1500 nm or between about 130 nm to 1300 nm or between about 150 nm and 1050 nm or between about 340 nm and 850 nm; and/or
wherein the spectra are detected with a spectral resolution of between about 0.1 nm and 1 nm or between about 0.2 nm to 0.8 nm or between about 0.4 nm to 0.6 nm.

10. The method according to claim 1, wherein the prediction value of the physical quantity and/or the classification is determined in real time and, based thereon, control data is output to a laser machining system performing the laser machining process.

11. The method according to claim 1, wherein the neural network is a trained neural network which can be adapted by means of training data by transfer learning.

12. A system for analysing a laser machining process, comprising:
at least one sensor unit which is arranged to detect a plurality of spectra of process emissions at successive points in time;
at least one computing unit which is arranged to generate at least one spectrogram based on the detected spectra as an input tensor; and
a neural network which is arranged to output at least one value of a physical quantity and/or a classification of the laser machining process as an output tensor based on the input tensor.

13. The system according to claim 12, wherein the sensor unit has at least one spectrometer or a MEMS spectrometer.

14. The system according to claim 12, wherein the at least one computing unit is designed to control the laser machining process on the basis of control data.

15. A laser machining system for machining a workpiece by means of a machining laser beam, comprising:
a laser machining head for irradiating the machining laser beam onto the workpiece; and
a system according to claim 12.
